(19) United States
(12) Patent Application Publication
(10) Pub. No.: US 2010/0326896 A1
(43) Pub. Date: Dec. 30, 2010

(54) SYSTEM INCLUDING A DIGESTER AND A DIGESTER EMULATOR

(75) Inventors: Vijaysai Prasad, Bangalore (IN); Amol Rajaram Kolwalkar, Bangalore (IN); Sunil Shirish Shah, Bangalore (IN); Frederick Liberatore, Carlsbad, CA (US); Rajendra Naik, Bangalore (IN)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/494,430

(22) Filed: Jun. 30, 2009

(51) Int. Cl. C02F 3/00

(52) U.S. Cl. 210/96.1; 210/150

(57) ABSTRACT

Disclosed herein is a system comprising a primary digester and a digester emulator. The digester emulator is capable of dynamically estimating the primary digester performance.

### BACKGROUND

The invention relates generally to systems including digesters and more particularly to systems also including means for estimating performance variations of a primary digester.

Soaring fuel prices and shrinking water resources together with emerging global norms for conservation of water and energy are forcing industries to manage their power and water utilization more efficiently. Thus, industries are identifying ways to attain a significant reduction in fossil-fuel-based power consumption and fresh water intake. One promising technology that enables significant reduction in power consumption and fresh water intake includes an integrated system having a water purification unit and a power generation unit. The power generation unit uses waste from the water purification unit to generate electrical power, and the integrated system operates on the electrical power generated by the power generation unit. Moreover, after meeting the power requirements of the integrated system, excess power is used for other applications.

Typically, key units or components of a water purification system include a digester and a membrane bioreactor, while a key unit of a power generation system is a reciprocating gas engine or the like. The water purification system releases biogas as a waste that is consumed by the reciprocating gas engine to generate electrical power. Further, the key units of the water purification system operate in a coordinated and an interdependent fashion such that any upsets or performance variations in any key unit affect functionality and performance of the rest of the key units. The wastewater feed stream (input feed) to the digester, for example, may have significant variations in flow rates, influent chemical oxygen demand, total suspended solids, total dissolved solids, temperature and pH. Such variations in the wastewater feed stream conditions may impact the digester performance and, in turn, likely impact operation of downstream process units, such as, the membrane bioreactor or biogas driven system. Moreover, performance variations in the water purification unit may result in significant variations in flow rate, composition and heating value of the biogas, resulting in tripping of the gas engine, ultimately resulting in upset (performance variation) and shutdown of the integrated system.

Conventionally, the process variations in the key units such as a digester are monitored by laboratory tests. Unfortunately, these laboratory tests are time consuming and in some instances are not sufficient for preventing upsets of the digester and thereby the integrated system. Also, considering the large size and the low rate of operation of the integrated system, the operator of the integrated system may be unable to detect any early anomalous behavior of the integrated system in a timely fashion, which in some cases may lead to costly shutdowns and maintenance.

It is therefore desirable to achieve robust and stable operation of the digester over long continuous periods of operation in the presence of wide-ranging input feed and process variations. Further, it is desirable to have means for both prior estimation and real-time monitoring of the variations and disturbances in the digester, and to take corrective actions to prevent the overall integrated system from stress related shutdowns.

The present invention fulfils the need of monitoring the performance variations of the digester, both in advance and real-time, based on feed and operation parameters.

### BRIEF DESCRIPTION

One embodiment of the present invention is a system comprising a primary digester and a digester emulator. The digester emulator is capable of dynamically estimating the primary digester performance.

Another embodiment of the present invention is a system comprising a primary digester and a digester emulator. A primary feed-line feeds the primary digester and a primary controller is disposed on the primary feed of the primary digester. A slipstream taken from the primary feed-line feeds the digester emulator. The digester emulator further contains at least one secondary feed-line and at least one sensor configured to sense a device parameter. In this configuration, the digester emulator is capable of dynamically estimating the primary digester performance.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a system with a digester.

FIG. 2 is a schematic representation of a system with a digester and digester emulator according to one embodiment of the invention.

FIG. 3 is a diagrammatical representation of a digester emulator according to one embodiment of the invention.

### DETAILED DESCRIPTION

Embodiments of the present invention include digester systems capable of estimating the performance variations of a digester both in advance and real-time, based on feed and operation parameters using a digester emulator.

In the following specification and the claims that follow, the singular forms “a”, “an” and “the” include plural referents unless the context clearly dictates otherwise.

Various embodiments of the present invention describe a system with a primary digester and a digester emulator such that the digester emulator is capable of estimating the performance variation of the primary digester.

Generally, digester systems operate on either aerobic digestion or anaerobic digestion. Aerobic digestion happens in the presence of oxygen while anaerobic digestion is a series of processes in which microorganisms break down biodegradable material in the absence of oxygen. Anaerobic digestion is widely used to treat wastewater sludge and organic waste as it provides volume and mass reduction of the input material. As part of an integrated waste management system, anaerobic digestion reduces the emission of landfill gas into the atmosphere. Anaerobic digestion is a renewable energy source because the process produces a methane and carbon dioxide rich biogas suitable for energy production thereby helping to reduce the consumption of fossil fuels. Also, the nutrient-rich solids left after digestion can be used as fertilizers.

Anaerobic digestion is particularly well suited to digest wet organic material and is commonly used for effluent and sewage treatment. Almost any organic material can be processed with anaerobic digestion http://en.wikipedia.org/wiki/-cite note-9 including biodegradable waste materials such as waste paper, grass clippings, leftover food, sewage and animal waste.

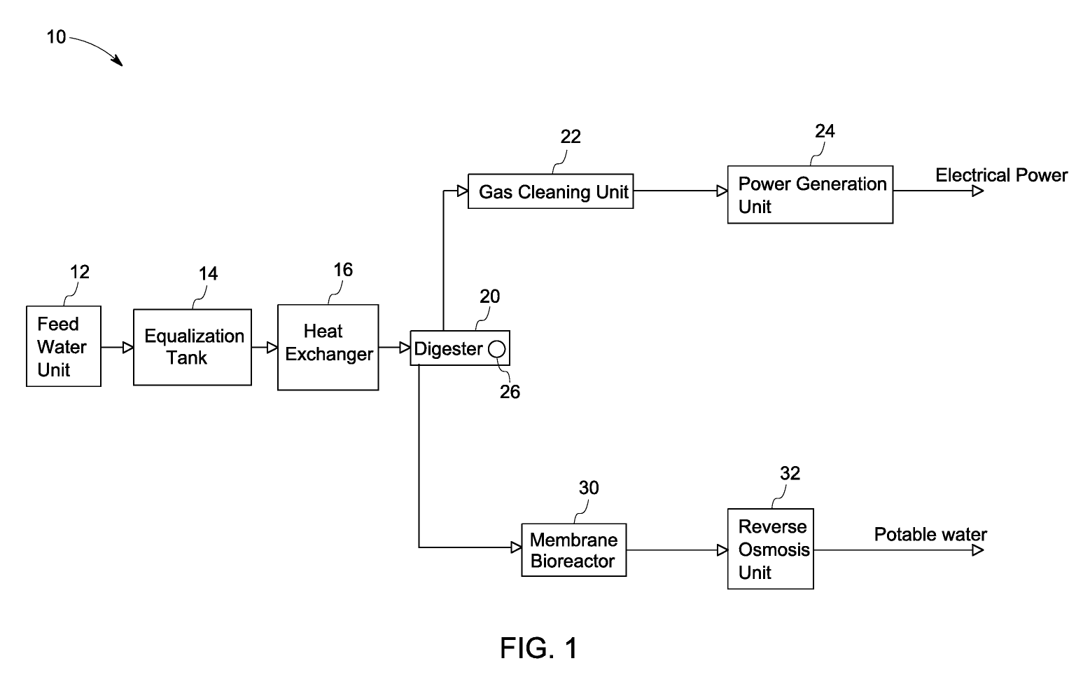

FIG. 1 is a diagrammatical view of an exemplary system 10. The system 10 includes a water purification system with capabilities of recovering purified water and valuable energy. Although the present invention is described with reference to a water purification system, other systems that use digesters also fall within the scope of this invention.

In one embodiment, the water purification system 10 includes a feed water unit 12 in operative association with an equalization tank 14, a heat exchanger 16 and a digester 20 that is operatively coupled to the heat exchanger 16. It may be noted that the heat exchanger 16 may include a shell and tube heat exchanger, a regenerative heat exchanger, an adiabatic wheel heat exchanger, a plate fin heat exchanger, a fluid heat exchanger, a dynamic scraped surface heat exchanger, a phase-change heat exchanger, a multi-phase heat exchanger or a spiral heat exchanger, for example. The feed water unit 12 intakes impure wastewater, or effluent of an industry and transfers to the heat exchanger 16. Further, the heat exchanger 16 regulates the temperature of the impure wastewater to a predetermined temperature for optimized working of the digester 20. In one embodiment, the digester 20 includes an anaerobic digester.

A digester comprises a tank, where an input feed to the digester and some types of bacteria coexist. The tank may be of any size or shape, but in general is of a size capable of accommodating a large amount of input feeds. In one embodiment, the digester tank is about 100 m³ of volume and cylindrical in shape. The digestion process begins with bacterial hydrolysis of the input materials in order to break down insoluble organic polymers such as carbohydrates. In the presence of bacteria (also known as suspended solid, microbe, biomass, and microorganism), the sugars and amino acids get converted into products such as carbon dioxide, hydrogen, ammonia, and some organic acids that eventually get converted into products containing methane. The contents of the digester often need to be in suspension and in many instances, the agitation produced by a flow of input feed and the flow of gas and liquid outputs keeps the contents of the tank in suspension.

In one embodiment, the digester 20 may extract substantial amounts of organic compounds from the impure wastewater received from the heat exchanger 16. Following the extraction of organic compounds from the impure wastewater, the digester 20 generates water cleared of organic compounds and releases biogas. Subsequently, the biogas is transferred to a gas-cleaning unit 22 that cleans the biogas of impurities resulting in a purified biogas. The impurities, for example, may include gases other than biogas, such as H₂S. The gas-cleaning unit 22 then transfers the purified biogas to a power generation unit 24 that generates electrical power (also called as captive power) utilizing the purified biogas. In certain embodiments, the power generation unit 24 may include a reciprocating gas engine. Further, the electrical power generated by the power generation unit 24 may be utilized for operation of the system 10. Also, in other embodiments, the electrical power may be utilized for operation of other industrial plants.

Subsequent to the generation of the water and an optional temperature regulation, the water is transferred to a membrane bioreactor (MBR) 30. While processing a higher sludge containing input feed, an alternate arrangement comprising a solid separator can be used and the liquid output of the solid separator can be directly fed to the MBR without going through the digester. Operation of a membrane bioreactor comprises an aerobic process that uses membranes to separate biomass to yield pure water. The membrane bioreactor 30 facilitates removal of any remaining organic compounds and also facilitates removal of substantial amount of suspended impurities from the water. Consequent to the removal of the remaining organic compounds and suspended solids by the membrane bioreactor 30 an effluent is produced. Further, the effluent is transferred to a reverse osmosis unit 32 that is in an operative association with the membrane bioreactor 30. The reverse osmosis unit 32 removes hard water minerals and total dissolved solids (TDS) from the effluent. Consequent to the removal of the hard water minerals and the TDS from the effluent, potable water is generated.

Anaerobic digester performance usually is governed by feed quality and operating conditions. For example, the bacteria responsible for anaerobic digestion are extremely sensitive to operating conditions and variations in the feed quality. The feed-line to the digester can be from any industry and the effluent of each industry will likely have different characteristics. The choice of solution, configuration, treatment and controls required for the digester will depend on the type of industry from which the effluents are used. The feed-line impacts water reuse and captive power, directly or indirectly. As depicted in FIG. 1, the digester 20 may include a sensing device 26 for sensing parameters such as total organic carbon (TOC), bacterial concentration or the quality of the primary feed. However, often, unnoticed variations in feed quality over a prolonged operation bring undesirable changes in digester performance. In addition, uncalibrated sensors, less reliable measurements, uneven mixing, localized concentration of few constituents, unnoticed air leakage, and other issues pose further challenges towards understanding the performance. Furthermore, wastewater parameters in a typical process plant keep changing depending on mode of operation and the source. However in an integrated system that generates electricity and reusable water, the digester performance needs to be consistent, reliable, and stable. These challenges enforce need for a suitable solution that not only helps in capturing effect of feed and operational parameters but also provide a platform to test unknown feed streams. Embodiments of the present invention include the use of a digester emulator, which works on a small fraction, called a slipstream, taken from the primary feed-line of the digester. In various embodiments, the digester emulator substantially mimics the performance of the actual digester.

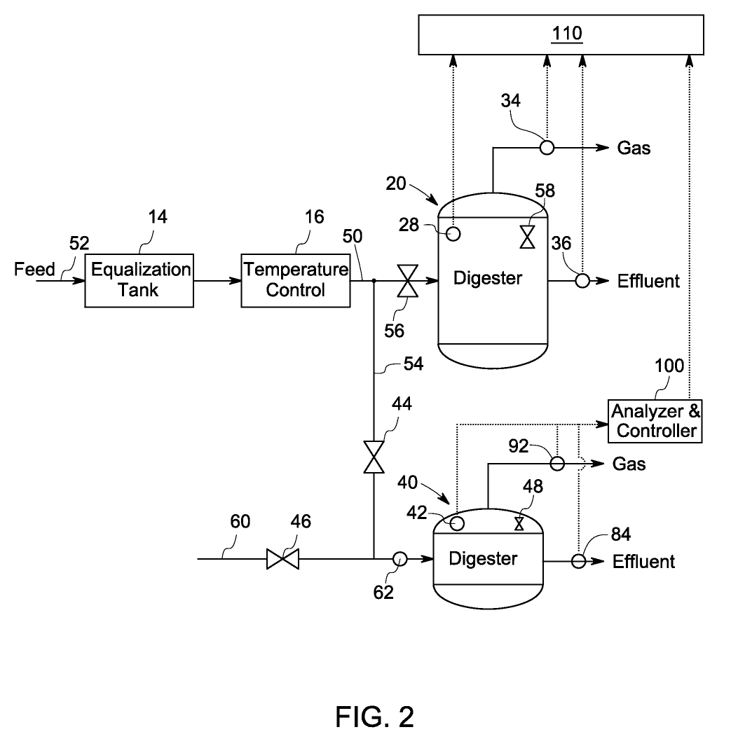

FIG. 2 schematically illustrates the arrangement of a primary digester 20 along with a digester emulator 40. The primary digester 20 can be used in the system 10 illustrated in FIG. 1 or in any other systems where digesters are used. The digester emulator 40 substantially mimics the performance of the primary digester 20, and therefore is capable of dynamically estimating performance of the primary digester 20. As used herein, the phrase “capable of dynamically estimating” indicates the non-limiting capability of the digester emulator 40 to estimate performance of the primary digester 20 during the operation of the primary digester 20 and the digester emulator 40 with a same primary feed taken from the primary feed-line 50. The term “mimics” herein means that considering the same quality of contents of the primary feed-line 50 for both the primary digester 20 and the digester emulator 40, the quality of the gas and water output of the digester emulator 40 is substantially similar to the quality of the gas and water output of the primary digester 20. The term “substantial” herein implies that the tolerable variations are within the acceptable limits of performance and quality. While the digester emulator 40 can estimate the dynamic variations of the primary digester 20 performance during the operation of primary digester, in a further embodiment, the digester emulator 40 can also predictably estimate the primary digester 20 performance prior to primary digester 20 operation. In this embodiment, the digester emulator is operated on the slipstream of the primary feed-line while the primary feed-line is decoupled from the primary digester. In this embodiment, the digester emulator works to estimate the capability of the primary digester and the parameter changes required for the optimum performance of the primary digester. Therefore, the digester emulator 40 is further capable of estimating the primary digester 20 performance even in the absence of operation of primary digester 20. The capability of digester emulator 40 to predictively estimate the primary digester 20 performance, particularly helps in assessing the primary digester 20 capability to take and work on a particular feed 52, even before passing the feed 52 to the primary digester 20 and also allows to assess and make the required changes in the feed 52 before the feed 52 enters the primary digester 20.

In one embodiment, as depicted in FIG. 2, the digester emulator 40 operates on a slipstream 54 taken from at least one primary feed-line 50 of the primary digester 20 through a controller 44. The slipstream feed-line 54 of the digester emulator 40 from a primary feed-line 50 of the primary digester 20 ensures that the quality of the primary feed 52 to the primary digester 20 and the digester emulator 40 are same and therefore the digester emulator 40 operates on the same primary feed 52 to estimate the performance of the primary digester 20. However, in another embodiment, the digester emulator 40 further has one or more supplementary feed-lines 60 through controller 46. The additional feed may assist the digester emulator 40 in estimating the primary digester 20 performance. In one embodiment, the feed 60 comprises an enhanced level of one of the device parameter (see below), without affecting the quality of the digester emulator performance to estimate the primary digester 20 performance. In an exemplary embodiment, the feed 60 contains additional microorganisms to enhance the rate of operation of the digester emulator 40 without affecting the estimation of the primary digester 20 performance. In another embodiment, the digester emulator further comprises sensors 62 on the input to the digester emulator.

Typically, the primary digester performance depends on many parameters, alternately also referred to as device parameters. Chemical oxygen demand (COD) is a measure of water quality. Normally expressed in milligrams per liter (mg/L), COD indicates the mass of oxygen consumed per liter of solution to fully oxidize all the organic compounds into carbon dioxide with a strong oxidizing agent under acidic conditions. While feed rate characterizes the input to the digester, the residence time or alternately hydraulic retention time (HRT) is the time that wastewater spends in the digester reactor. In a typical anaerobic digester, the HRT can vary from about 2 hours to about 10 days. For an optimum utilization of a digester, one would like to reduce the HRT without compromising over the water or power output of the system.

The quantity of Suspended solids in the digester directly affects the digestion time of the input feed. A high amount of suspended solids will be able to purify the input feed faster. However, once the optimum quantity of the suspended solids is reached, there may not be further substantial increase in the efficiency of the digestion. A higher level of suspended solids in the digester can be maintained by supplying more suspended solids or by recycling the suspended solids that may be carried through the effluent output of the digester. However, in the digesters of large volumes, it is difficult to separate and retain the suspended solids from the effluents. Solid retention time (SRT) is another parameter generally used in digesters. SRT typically signifies the time suspended solids spend in the reactor. Higher SRT, without compromising on the digester outputs, generally implies higher overall efficiency of the microorganisms and therefore, it is generally desired to operate the digesters in higher SRT. One way of increasing SRT is to retain the microorganisms in the digesters. Typically the SRT of primary digesters are in the range of 2 days to 50 days because of design difficulties in retaining the microorganisms, while the SRT of the digester emulator is in the range from 20 days to 50 days. Hence, in general, the digesters of large volumes operate in high HRT and high SRT. The digester emulator is typically of small size compared to primarily digesters and operates on the methodology of operating in lower HRT and higher SRT. This approach helps the digester emulator to respond much faster to disturbances to the device parameters.

Another device parameter is the temperature. Temperature of the feed-line and temperature of the digester affects the overall operation of the digester. A constant and uniform temperature in the digester is desirable for the smooth functioning of the digester. One of the factors considered for setting the temperature of the digester contents is the optimum temperature for the microorganisms to work on the wastewater. While a higher temperature can hamper the useful life of the microorganisms, in certain embodiments, the lowering of temperature can lower the activity of microorganisms and hence increase the residence time of the water in the digester. In one embodiment, temperature of about 28° C. to about 38° C. is used for the smooth functioning of an anaerobic digester.

pH of the contents of the digester is another parameter for the digester operation. pH is often an important parameter for the smooth operation of the digester. The pH range to be controlled varies with the types of digesters. In one embodiment, the pH is in the range from about 6.9 to about 7.4. Variation in the pH, especially the decrease in pH, during the operation of digester is usually considered as an indication of digester upset. Another parameter in the digester performance is the alkalinity of the digester contents. The digester contents are maintained at very low levels of alkalinity for resisting changes in pH and, in one embodiment, includes the addition of calcium carbonate (CaCO₃) to the digester. pH and alkalinity of the digester contents can be affected by several other factors such as, for example, inclusion of nitrogen, volatile fatty acids (VFA), sulphates, and bicarbonates in the digester contents. In one embodiment, the alkalinity is measured by the amount of bicarbonates as CaCO₃ in the digester contents and in another embodiment, CaCO₃ in a range of about 1800 to 5000 ppm is used to stabilize the pH of the digester contents.

Nutrients used for the microbial growth are another parameter affecting digester operation. Examples of nutrients include NH₃, phosphate, and sulfur. Maintaining the desired level of nutrient concentration in the feed or digester is useful for the health and growth of microbes in the digester. Micronutrients such as cobalt, nickel, iron, molybdenum, and tungsten generally help in the conversion of acetates in the water to methane. However, any excess of nutrients or micronutrients can be toxic for the operation of the digester along with any other detrimental ingredients and is considered as toxicity or toxic parameter. Toxicity can arise from the feed-line itself or by other means including plant cleaning and batch failures. Toxicity can be acute or chronic and at times will be difficult to detect or monitor in the digester. However, certain changes in other parameters or operational conditions such as disappearance or decrease of hydrogen or methane, decrease in pH or alkalinity, or increase in VFA can help predict possible ingredients and thereby the toxicity. Depending upon the nature of toxicity, effects of toxicity may include some or all of the above mentioned indications. In addition to toxicity, several other factors can also affect digester operation. Examples of these factors include feed-line fluctuations, organic or hydraulic overload, air contamination, and sludge withdrawal.

While only some of the parameters are described in earlier paragraphs, there can be many parameters that affect the digester and digester emulator performance. Without limiting the list, other parameters include, for example, feed quantity, feed quality, Redox potential, biogas quality, mixing number, coefficient of axial dispersion (CAD), and flow rate.

Typically, the primary digester 20 size ranges from few hundred to few thousand m³ of volume. The digester emulators 40 generally use a scaled down size approach to estimate the primary digester 20 operation. In one embodiment, the digester emulator 40 is a scaled down model of the primary digester 20, and the size of the digester emulator 40 varies from below 1 m³ to about 5 m³ volume. While the digester emulator 40 uses the scaled down size approach, it need not have the same length to breadth or length to diameter ratios of the primary digester 20. In one embodiment, the primary digester 20 and digester emulator 40 are in approximately cylindrical shape and the length to diameter ratio of the digester emulator 40 is not proportional to the ratio of the primary digester 20. While there may be different sensors 28 in the primary digester 20, due to large size of the primary digester, there can be a time delay in sensing the variation of any parameter through the sensors 28 and control the variation in parameters. Digester emulator 40 typically has reduced size and also can operate at a higher rate than the primary digester 20, and therefore, can more effectively sense and give the feedback about the expected performance of primary digester.

Typically, the digester emulator 40 determines the effect of one or more device parameters to dynamically estimate the performance of primary digester 20. In general, the parameters that are mainly used to estimate or mimic the primary digesters are the mixing number, HRT, SRT, and CAD. In one embodiment, the digester emulator 40 operates at a modified level of one or more device parameters as compared to the primary digester 20. In another embodiment, the digester emulator 40 operates at a different average SRT than the primary digester 20. In yet another embodiment, the digester emulator 40 operates faster than the primary digester 20 and is able to give the estimated output quality of the primary digester 20. For example, the digester emulator 40 can operate at higher average SRT than the primary digester 20, which enables the digester emulator 40 to reduce HRT and work faster, giving the same output quality as the primary digester 20 that operates at higher HRT and hence takes longer time. In one more embodiment the digester emulator 40 can operate at a lower level of average SRT than the primary digester 20 for different applications, for example, to induce a greater disturbances in the primary digester or to increase the COD of the effluent out put of the primary digester 20.

The primary digester 20 can further comprise sensors 28 and controllers 56, 58 to sense and control the device parameters. Similarly the digester emulator 40 can further comprise sensors 42, 62 and controllers 56, 58, 44, 46, 48 to sense and control the device parameters. In certain embodiments, the sensing device 42 of the digester emulator 40 may include a gas flow meter, and one or more sensors. The controls 56, 58, 44, 46, 48 can be used to control one or more of the device parameters directly or indirectly. The sensors can be configured individually or in combination to sense parameters including, for example, any one or more of the following: chemical oxygen demand (COD), temperature, pH, gas quantity, gas composition, mixed liquor suspended solids, volatile fatty acids (VFA), oxygen reduction potential, and alkalinity. Controllers 56, 58, 44, 46, 48 can control, along with others, the temperature of, and loading conditions of, the digester emulator; HRT; nutrient and micro nutrients dosing; alkalinity and pH of the digester contents; and recycling, start-up and end of the operations.

The response output of the digester emulator can be sensed through the sensors 42, 84, and 92 and analyzed in a “digester emulator analyzer and controller” 100. The digester emulator analyzer and controller 100, in signal communication with the sensors of digester emulator, helps to optimize the device parameters of the digester emulator and also to estimate and control the variation in primary digester performance. The digester emulator analyzer and controller 100 can be an automatic machine or the devices operated with human interference. In one embodiment, the primary digester and the digester emulators are further in signal communication with a process analyzer 110. The process analyzer 110 takes input from the sensors 28 of the primary digester, one or more gas sensors 34, one or more effluent sensors 36, and the digester emulator analyzer and controller 100 to analyze the flow related or any other miscellaneous parameters related performance differences of the digester emulator and primary digester. The historical learning of the analysis of the process analyzer 110 can be used to estimate and further modify the primary digester parameters for optimizing the primary digester performance.

In one embodiment, the digester emulator further comprises at least one feed back arrangement. This feed back arrangement can feed a part of the output of the digester emulator 40 back into the digester emulator. In one embodiment, the digester emulator can contain one or more physical barriers for some of the outputs. In another, related embodiment, the digester output can contain a physical barrier for suspended solids in the output. For example, the digester emulator can comprise one or more membranes for filtering the bacteria from the output and feed it back to the digester emulator so as to increase the bacterial concentration in the tank and thereby increase the SRT and rate of operation of the digester emulator.

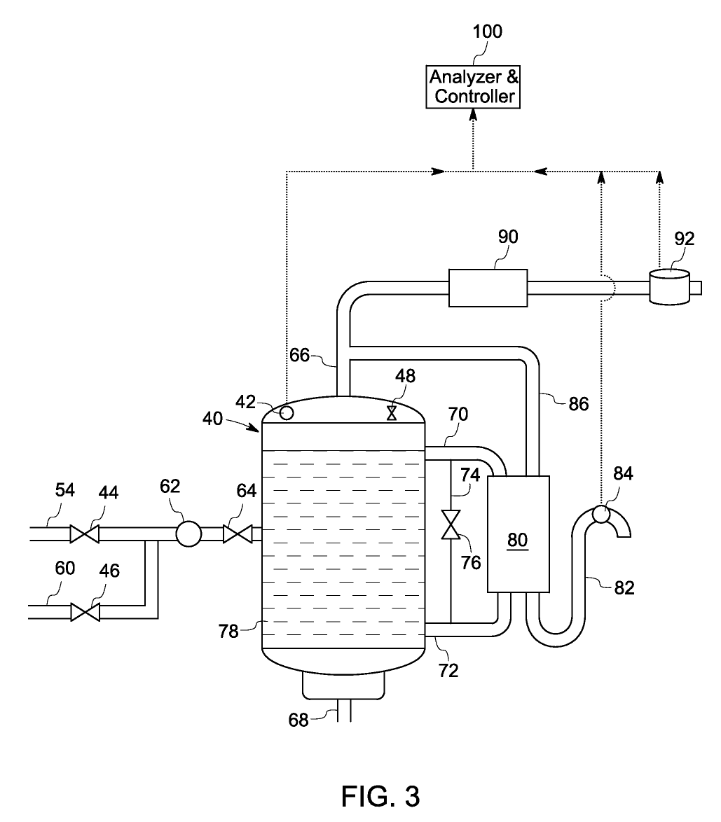

Considering FIG. 3, in one embodiment, the digester emulator 40 comprises a primary feed-line 54 with one or more controllers 44 and one or more secondary feed-lines 60 with one or more controllers 46. The controllers 44 and 46 can be applied to control any device parameters including the flow rate of the feeds. The feed-lines 54 and 60 can optionally have sensors (not shown) for any of the device parameters. The primary and secondary feeds can go through further one or more sensors 62 and one or more controllers 64, before entering the digester emulator 40. The digester emulator can further contain the different sensors 42 and controllers 48. The sensors 42 and controllers 48 can sense and control respectively any of the device parameters inside the digester emulator 40. For example, the sensors 42 may sense the alkalinity, bicarbonates present in the contents of digester emulator 40, ammonia, redox potential of the contents, pH, or VFA individually or in combination with another. Controllers 48 can control, for example, the temperature or stirring of the contents of the digester emulator 40. The digester emulator 40 in some embodiments further comprises at least one gas outlet 66, sludge outlet 68, an effluent output 70 and a feed back arrangement 72, for the digester emulator contents 78. The effluents either pass through a solid separator 80 or directly pass through the direct feedback line 74, 72 through a controller 76. The direct feedback of the effluents back into the digester emulator makes the contents to go through the digestion process again. When the effluents pass though a physical solid separator 80, the solid and liquid contents get separated. The solid content primarily comprising the suspended solids can pass back to the digester emulator through the feed back line 72 and the liquid content, for example water, can pass through the water output line 82 and a sensor 84. The physical solid separator can comprise a membrane to separate the solid and liquid contents of the effluents. The sensor 84 can check the quality of the output liquid content. The gas output from the solid separator 80 joins the digester emulator gas output line 66. The gas outputs of the digester emulator 40 and the solid separator 80 further passes through a moisture sensor 90 and at least one gas output sensor 92 for checking the quality of the gas output. For example, the gas output sensor 92 can sense composition and flow of the gas output. The sensor 42, 84, and 92 inputs to the digester emulator analyzer and controller 100 helps in estimating the performance of the primary digester 20.

The capability of digester emulator to mimic the primary digester operation and estimate the quality of the output of primary digester, along with others, may help to improve the benchmark performance of the primary digester to the best achievable performance, to isolate the cause of deviation, to capture effects of extraneous parameters on bacterial growth leading to biological degradation, may provide a platform to test change in operational conditions in terms of change in loading rate, temperatures, nutrient additions, and other parameters, and also may enable testing the effect of unknown feed compositions of the primary digester. In the event of supplying power output of a system including the primary digester to a grid, the digester emulator can be used to analyze the primary digester's optimum performance period and adjust the start-up timing of primary digester and primary digester performance to give maximum power output to the grid during the maximum demand for the power.

The digester emulator is designed and operated in such a way to substantially correlate the performance of the digester emulator with the primary digester. For example, consider an anaerobic primary digester of about 1000 m³ volume taking a feed of about 100 m³ of wastewater with the COD (chemical oxygen demand) of about 10 kg/m³ in a day. If the COD of the product coming out of the primary digester has a COD of 1 kg/m³, the biomass or the amount of bacteria required in the digester can be calculated as below:

$$\begin{matrix}Total C O D in Feed = Flow \times C O {D}_{feed} \\ = 100 {m}^{3} \text{/} day \times 10 kg \text{/} {m}^{3} \\ = 10 , 00 kg \text{/} day\end{matrix}$$

$$\begin{matrix}Total C O D in Product = Flow \times C O {D}_{product} \\ = 100 {m}^{3} \text{/} day \times 1 kg \text{/} {m}^{3} \\ = 10 \; 0 kg \text{/} day\end{matrix}$$

$$\begin{matrix}C O D consumed = 10 , 00 - 1 , 00 kg \text{/} day \\ = 9 , 00 kg \text{/} day .\end{matrix}$$

Experimental testing has indicated that the cell yield or the biomass required is about 20 g/100 g of COD.
Therefore, Cell yield=9,00×0.2=1.80 kg/day

Therefore, about 180 kg of bacteria is required to digest 900 kg of COD.

$$\begin{matrix}The hydraulic retention time = 1000 {m}^{3} / ( 100 {m}^{3} \text{/} day ) \\ = 10 days .\end{matrix}$$

The retention of bacteria is difficult in digesters of bigger volumes as 1000 m³ and in normal conditions the bacteria accompany the effluent and are lost from the digester. When bacteria are not retained in the digester, SRT=HRT.

Hence the residence time of the bacteria is also similar to the residence time of the feed in the digester.

$$Therefore , the total bacteria needed for the digestion of the total feed = 180 kg \text{/} day \times 10 days = 1800 kg . \\ Then the bacteria or biomass concentration in the digester = 1800 kg / 1000 {m}^{3} = 1.8 kg \text{/} {m}^{3}$$

However, if the bacterial loss is avoided, then the reactor size can be significantly reduced to treat the same amount of feed as can be explained based on Monod's kinetics given by equation 1 below.

$$H R T = ( \frac{S R T}{X} ) ( \frac{Y ( {S}_{o} - S )}{1 + {k}_{d} S R T} ) \qquad ( 1 )$$

where

X=Biomass concentration. 1.8 kg/m³

SRT=10 days

S0=Influent concentration=10 kg/m³

S=effluent concentration=1 kg/m³

Kd=death coefficient=0.1/day

Y=Yield=0.4 kg of VSS Kg of COD.

The amount of Kd and Y are approximations generally known and used in the art.

If the loss of biomass is avoided by retaining the biomass, for example through a retention means such as a membrane for the suspended solid and feeding the retained biomass back to the digester, for an effective SRT of 30 days and biomass concentration X=5.4 kg/m³, then the required HRT can be calculated by Monod's kinetics given by equation 2 as

$$H R T = ( \frac{30}{5.4} ) ( \frac{0.4 ( 10 - 1 )}{1 + 0.1 ( 30 )} ) \qquad ( 2 )$$

Then the calculated HRT is 5 days.
Assuming the about 1 m³ input feed per day as the primary digester, the volume of the digester emulator is given by

$$\begin{matrix}Volume = H R T \times flow rate \\ = 5 days \times 1 {m}^{3} \text{/} day \\ = 5 {m}^{3} .\end{matrix}$$

Hence the volume of the digester emulator can be reduced by changing the biomass concentration and SRT without compromising on the feed treatment by the biomass. By controlling the other device parameters related to operation of the digester, the environment in the primary digester could be simulated in the digester emulator and thereby improve the predictability of the primary digester performance based on the digester emulator operation. The process analyzer 110 can evaluate the historical sensor signals of both primary digester 20 and digester emulator 40 and can be used for the finer adjustments of the device parameters needed to be carried out in the digester emulator for improving the predictability.

The benefits of introducing a digester emulator along with the primary digester include, along with others, ability to test unknown feed with respect to treatment efficiency and gas production; ability to test and implement new operating conditions like temperature, pH, organic loading; ability to detect and isolate factors responsible to degradation in the primary digester performance; ability to detect sensor worthiness of primary digester by frequent sample collection and testing; ability to test new enzymes, nutrients and bacterial-strains without affecting the primary digester; and ability to identify precursors of failures more precisely before the failures. One example of the failure precursors is change of redox potential prior to pH excursion.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a primary digester; and
a digester emulator capable of dynamically estimating the primary digester performance.

2. The system of claim 1, wherein the digester emulator is disposed in fluid communication with a slipstream taken from at least one primary feed-line to the primary digester.

3. The system of claim 1, further comprising at least one supplementary feed-line in fluid communication with the digester emulator.

4. The system of claim 1, wherein the digester emulator is a scaled down model of the primary digester.

5. The system of claim 1, wherein the digester emulator further comprises at least one sensor disposed to sense at least one selected parameter of the digester emulator.

6. The system of claim 5, wherein the at least one selected parameter is selected from the group consisting of chemical oxygen demand (COD), temperature, pH, gas quantity, gas composition, mixed liquor suspended solids, volatile fatty acids (VFA), oxygen reduction potential, and alkalinity.

7. The system of claim 1, wherein the digester emulator further comprises at least one controller to control at least one selected parameter of the digester emulator.

8. The system of claim 7, wherein the at least one selected parameter is selected from the group consisting of chemical oxygen demand (COD), temperature, pH, gas quantity, gas composition, mixed liquor suspended solids, volatile fatty acids (VFA), oxygen reduction potential, and alkalinity.

9. The system of claim 1, wherein the digester emulator further comprises at least one feed back arrangement to feed suspended solids back to digester emulator.

10. The system of claim 9, wherein the digester emulator further comprises at least one physical barrier for suspended solids.

11. The system of claim 1, wherein the digester emulator further comprises at least one digester emulator analyzer and controller in signal communication with the digester emulator.

12. The system of claim 1, wherein the system further comprises a process analyzer to correlate the performance variation of the primary digester and digester emulator.

13. A system comprising:
a primary digester;
a digester emulator;
a primary feed-line feeding the primary digester;
a slipstream feed-line from the primary feed-line feeding the digester emulator;
at least one controller disposed on the primary feed-line of the primary digester;
at least one secondary feed-line to the digester emulator; and
at least one sensor configured to sense a device parameter of the digester emulator
wherein the digester emulator is capable of dynamically estimating the primary digester performance.

14. The system of claim 13, wherein the digester emulator is a scaled down model of the primary digester.

15. The system of claim 13, wherein the digester emulator comprises a different average solid retention time (SRT) compared to the primary digester during operation of the digester emulator.

16. The system of claim 15, wherein the digester emulator comprises a greater average solid retention time compared to the primary digester during operation of the digester emulator.

17. The system of claim 15, wherein the digester emulator comprises a lower average solid retention time compared to the primary digester during operation of the digester emulator.

18. The system of claim 13, wherein the digester emulator further comprises at least one membrane for retaining bacteria.
